(19) United States
(12) Patent Application Publication
(10) Pub. No.: US 2015/0095805 A1
(43) Pub. Date: Apr. 2, 2015

(54) INFORMATION PROCESSING APPARATUS AND ELECTRONIC CONFERENCING SYSTEM

(71) Applicant: Sharp Kabushiki Kaisha, Osaka (JP)

(72) Inventor: Yuki Shibayama, Osaka (JP)

(21) Appl. No.: 14/497,646

(22) Filed: Sep. 26, 2014

(30) Foreign Application Priority Data
Sep. 30, 2013 (JP) 2013-204445

(51) Int. Cl. G06F 3/0484; G06F 3/0354; H04L 12/18

(52) U.S. Cl. CPC G06F 3/0484; H04L 12/1813; G06F 3/03545
USPC 715/753

(57) ABSTRACT

An electronic conferencing system connects a main device and a terminal in a communicable manner while allowing an image file to be shared therebetween for mutually displaying. The main device includes a tablet that receives a designation operation of a position on a screen of its display section; and a drawing processing section that creates drawing information, based on which a designation position designated by the tablet is displayed in blue, and drawing information, based on which, in response to an instruction operation of another new series of position, the display of the designated position is changed in color from blue to red. Such drawing information, is transmitted to the terminal for displaying on the terminal side.

### CROSS REFERENCE

This Nonprovisional application claims priority under 35 U.S.C. §119(a) on Patent Application No. 2013-204445 filed in Japan on Sep. 30, 2013, the entire contents of which are hereby incorporated by reference,

### BACKGROUND OF THE INVENTION

The present invention relates to information processing apparatuses and electronic conferencing systems to progress an electronic conference while displaying an image file in a shared manner.

Conventionally electronic conferencing systems to progress a conference while displaying an image at terminals at mutually distant places in a shared manner have been known. Japanese Unexamined Patent Application Publication No. K05(1993)-56425 describes an electronic conferencing system, including a plurality of terminal devices 2 to 4 that are connected via a common display device 1 and a network. When information is input from the terminal 2 in a shared mode, such information is transmitted to the common display device 1 and a shared file is created therefrom, which is then transmitted to the other terminals 3 and 4, thereby displaying a shared image at the individual terminals. Japanese Unexamined Patent Application Publication No. 2003-281101 describes another electronic conferencing system, including a server 1 and clients 3 to 6 that are mobile display pads that participants of the conference use, which are connected via a wireless LAN. The electronic conferencing system described in Japanese Unexamined Patent Application Publication No. 2003-281101 is configured so that, in response to a touch tor inputting of a touch panel that is disposed on a large-sized screen of the server 1, image data containing coordinates of the touch for inputting are transmitted to the clients 3 to 6 to display a screen to be shared. The electronic conferencing system described in Japanese Unexamined Patent Application Publication No. 2003-281101 is configured so that, when one of the clients 3 to 6 uses a predetermined application to display any document on the window to display a shared screen, then the same document will be displayed on the windows to display a shared screen of a large-sized display device 2 and the other clients 3 to 6, According to the inventions described in these patent documents, an image to be shared that is input from a terminal is displayed at the other terminals as a shared image, thereby enabling smooth progressing of the conference.

According to the inventions described in Japanese Unexamined Patent Application Publication Mo. H05(1993)-56425 and Japanese Unexamined Patent Application Publication No. 2003-281101, they are configured so that drawing information that is input from another terminal at any timing is transmitted to the terminal of the user and is drawn at any place in the screen of the display section thereof. In this case, the user of the terminal may not notice the drawing, and especially when coordinates input are simply displayed as drawn contents or when the user keeps his/her eyes on another place on the screen, the user may overlook such a drawing. To avoid this, the operation state of an operator who operates the other terminal may be captured as a video, and such a video may be delivered to each terminal, whereby such an image of the action can be directly checked visually. This can confirm the drawing operation and the drawing position, and so the possibility of overlooking can be avoided. To this end, however, a camera has to be separately disposed so as to capture an image of the display part of the terminal from, the front-face side.

It is an object of the present invention to provide an information processing apparatus and an electronic conferencing system to display information so that the input position of the information is displayed in a temporarily conspicuous drawing form, thus facilitating the checking of the input position on the side of the other information processing apparatuses.

### SUMMARY OF THE INVENTION

An information processing apparatus of the present invention having a display section performs a communication with another information processing apparatus having a display section to share an image file therewith, and displays the image file at both of the display sections of the information processing apparatuses so as to progress an electronic conference therebetween. The information processing apparatus includes: an input section and a drawing information creation section. The input section receives a designation operation of a position on a screen of the display section. The drawing information creation section creates first drawing information, based on which a designation position designated by the input section is displayed in a first drawing form, and second drawing information, based on which, when a predetermined condition holds after reception of the designation position, display of the designated position is changed into a second drawing form. The information processing apparatus transmits the first and the second drawing information to the other information processing apparatus.

### BRIEF DESCRIPTION OF THE DRAWINGS

FIGS. 1A and 1B illustrate the overall configuration, of an electronic conferencing system that is Embodiment 1 according to the present invention, where FIG. 1A shows the configuration on the main device side and FIG. 1B shows the configuration on the terminal side.

FIGS. 2A and 2B illustrate a screen to describe a first drawing method in accordance with drawing information, where FIG. 2A shows a screen during special display, and FIG. 2B shows a screen in the state of a change from special display to normal display.

FIG. 3 is a flowchart to describe the first drawing method for the main device side and for the terminal side.

FIGS. 4A and 4B illustrate a screen to describe a second drawing method in accordance with drawing information, where FIG. 4A shows a screen during special display, and FIG. 4B shows a screen after a change to normal display.

FIG. 5 is a flowchart to describe the second drawing method for the main device side and for the terminal side.

FIGS. 6A and 6B illustrate screens to describe a third drawing method in accordance with drawing information, where FIG. 6A shows a screen on the main device side and FIG. 6B shows a screen on the terminal side.

FIG. 7 is a flowchart to describe the third drawing method for the main device side and for the terminal side.

FIGS. 8A, 8B and 8C illustrate screens to describe a fourth drawing method in accordance with drawing information, where FIG. 8A shows a screen on the main device side, FIG. 8B shows a screen on the terminal side during special display and FIG. 8C shows a screen on the terminal side after a change to normal display (deletion).

FIGS. 9A, 9B and 9C illustrate screens to describe a fifth drawing method in accordance with drawing information, where FIG. 9A shows a screen on the main device side, FIG. 9B shows a screen on the terminal side during special display and FIG. 9C shows a screen on the terminal side after a change to normal display (deletion).

### DETAILED DESCRIPTION OF THE INVENTION

### Embodiment 1

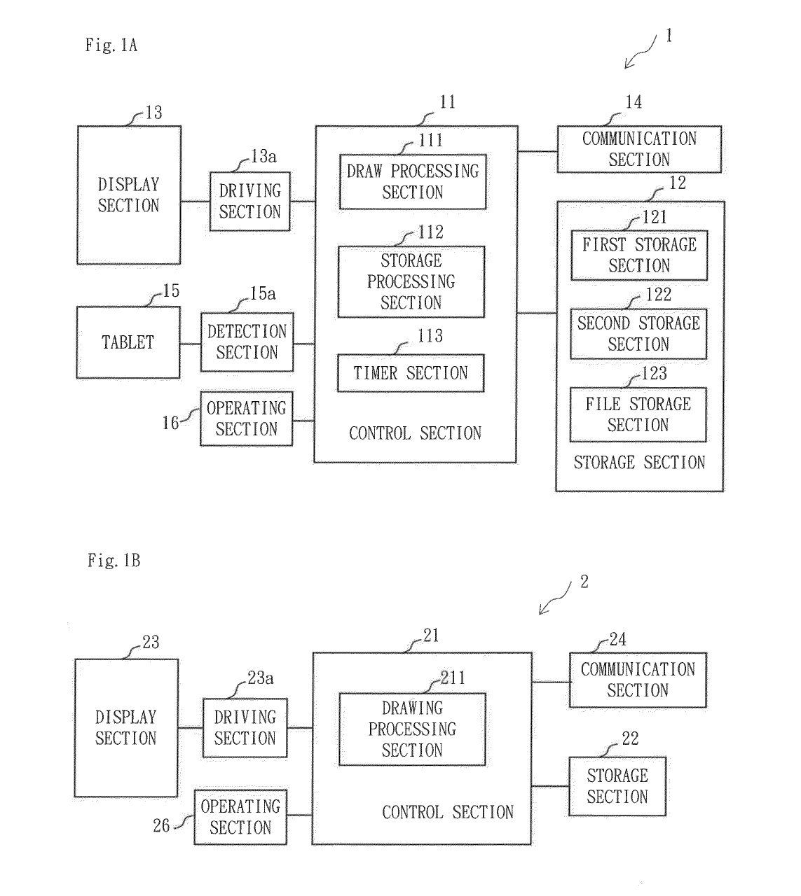

In FIGS. 1A and 1B, an electronic conferencing system, of the present embodiment includes a main device 1 and a terminal 2 as a sub-device that is connected to the main device 1 via a network. The electronic conferencing system enables one or a plurality of terminals 2 to participate in an electronic conference. The main device 1 and the terminal 2 are made up of microcomputers. The main device 1 includes a control section 11 provided with a central processing unit (CPU). A storage section 12, a display section 13, a communication section 11, a tablet 15 and an operating section 16 are connected to the control section 11. As is well known, although the main device 1 as well as the terminal 2 is provided with a speaker and a microphone to enable an electronic conference therebetween, the following mainly describes the configuration and the operations relating to the drawing processing.

The storage section 12 includes: a first storage section 121 and a second storage section 122 to store coordinates information that is input by a conference participant who operates the main device 1 while associating the coordinates information with a drawing form; and a file storage section 123 to store various types of text files that are materials of the conference to be provided at the electronic conference. The storage section 12 further includes a storage section of a control program to run the electronic conferencing system and a work memory section to temporarily store processing data.

The display section 13 includes a liquid crystal display panel having a predetermined size, and the like to display an image under the driving by a driving section 13a. The communication section 14 enables a communication of information with other terminals 2 via a network in accordance with a communication protocol. Exemplary network includes the Internet as well as a local area network (LAN).

The tablet 15 is a plate-like pointing device receiving an input operation, using a pen-form tool such as a stylus or receiving a direct handwriting input operation, and in this example, this includes a transparent touch panel, for example, that is attached to the front face of a display face of the display section 13. The tablet 15 may be of various types such as an infrared type as well as of an optical type or a capacitance type to detect coordinates input. A detection section 15a detects pressed positions of the tablet 15 as input coordinates periodically and outputs them to the control section 11. The operating section 16 includes a pointing device such as a mouse, and a keyboard to input information and instructions, for example.

The control section 11 reads a control program stored in the storage section 12 for execution, so that the control section 11 functions as a draw processing section 111, a storage processing section 112 and a timer section 113.

Receiving an instruction from the operating section 16 during the electronic conference, the draw processing section 111 reads a text file or the like from the file storage section 123 of the storage section 12 and displays it at the display section 13. This is typically performed by writing the text file or the like in a RAM for display, which is associated with display coordinates of the display section 13, reading the same at the frame period, and displaying it at the display section 13 as a still image. The draw processing section 111 captures coordinates information on the touch for inputting to the tablet 15 periodically, which is obtained via the detection section 15a. The draw processing section 111 associates the coordinates of the tablet 15 and the display coordinates of the display section 13 beforehand, thereby performing a trace drawing processing such as drawing of a trace, for example, at a position in the screen corresponding to coordinates input by handwriting. This trace drawing processing will be described later.

The draw processing section 111 further performs, based on input coordinates information captured from the tablet 15, processing to create drawing information for special display described later and processing to rewrite the drawing information to change it from a special display to a normal display, and writes such drawing information to the first storage section 121 and the second storage section 122 via the storage processing section 112. The first storage section 121 stores drawing information for special display and the second storage section 122 stores drawing information for normal display. The drawing information contains a group of input coordinates that are captured periodically from the tablet 15 as well as predetermined color data and density data for drawing corresponding to the coordinates, which are set as a position mark. Such a position mark is drawn at the coordinates of the group of input coordinates that are captured with time, whereby the tracing image as a whole can be defined.

To execute the drawing processing at the display section 13, the draw processing section 111 reads the drawing information stored at the first storage section 121 and the second storage section 122, synthesize it with a text file and outputs the resultant to the display section 13. The draw processing section 111 also outputs the drawing information stored at the first storage section 121 and the second storage section 122 to the communication section 14 periodically via the storage processing section 112. Then, the communication section 14 transmits such drawing information to the terminals 2 of the participants who participate in the electronic conference to share the displayed contents at the electronic conference.

In response to an instruction from the draw processing section 111, the storage processing section 112 writes and reads a text file and drawing information with respect to the storage section 12. The timer section 113 manages time-based information that is necessary for special display and normal display described later. The control section 11 further performs processing to execute general management processing to manage the terminals 2 participating in the conference, for example, at the time of activation or during the progressing of the electronic conference and control communications among the terminals 2 participating in the conference.

The terminal 2 includes a control section 21 provided with a central processing unit (CPU). A storage section 22, a display section 23, a communication section 24 and an operating section 26 are connected to the control section 21. The display section 23, the communication section 24 and the operating section 26 have the same functions as those of the display section 13, the communication section 14 and the operating section 16 of the main device 1. The storage section 22 stores a sub-control program for participation to an electronic conference, and stores a text file and drawing information that are transmitted from the main device 1 during the electronic conference. The control section 21 reads the sub-control program for execution, thus functioning as a drawing processing section 211. The drawing processing section 211 draws a text file that is transmitted from the main device 1 and written in the storage section 22, and executes drawing processing in accordance with the drawing information. This allows the display contents to be shared between the main device 1 and the terminal 2.

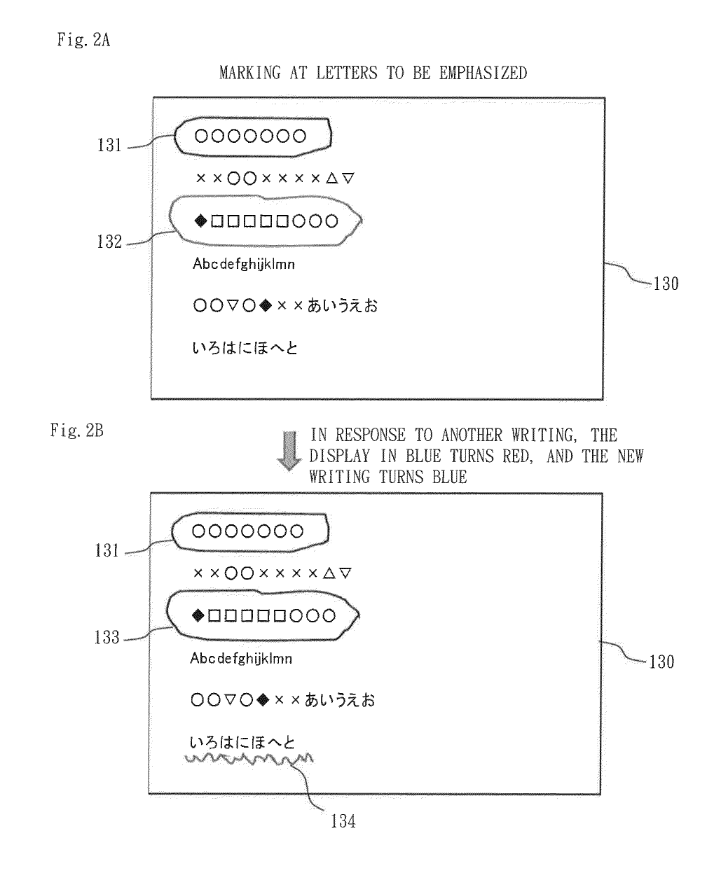

Referring now to FIGS. 2A and 2B, the following describes a first drawing method in accordance with drawing information.

The first drawing method is as follows. In response to a detection of a series of input operation (typically from pen-down to pen-up) to the tablet 15, drawing information is created for special display (a first drawing form) from the timing of the detection, until a certain condition holds, e.g., until another series of input operation starts, and is displayed at the display section 13 (and the display section 23). Next, when the otter series of input operation starts, the drawing information is rewritten with drawing information of normal display, and normal display (a second display form) is performed at the display section 13 (and the display section 23) based on the drawing information after rewriting.

The drawing information is transmitted to the terminal 2, whereby an image on the screen 130 in FIG. 2A can be displayed similarly on the screen of the display section 23 as well. This means that, immediately after the input operation to the tablet 15, special display is performed at the display section 23 of the terminal 2, and so the position of the input operation can be displayed in an eye-catching manner.

The screen 130 of FIG. 2A displays a text file (conference materials) including character strings such as “◯◯◯ . . . ”, “XX◯ . . . ”, “♦□□ . . . ”, and “ [symbol] . . . ” in a specific color, e.g., black, on a ground color. A surrounding mark 131, corresponding to coordinates that are designated with a series of input operation, is displayed so as to surround the character string “◯◯◯ ” in the screen 130. The conference is progressed while letting participants refer to this screen 130. A participant of the conference who operates the main device 1 traces over the display section 13 using a stylus, so that input coordinates traced are detected as a continuous linear trace at the tablet 15, and then this surrounding mark 131 is displayed firstly as a blue surrounding mark at the corresponding position of the screen 130.

FIG. 2A further illustrates the state of the screen 130 immediately after a series of input operation so as to surround a new character string “♦□□ . . . ”. In this way, when the series of input operation is performed so as to surround the new character string “♦□□ . . . ”, the surrounding mark 131 of the character string “◯◯◯. . . ” displayed, in blue, for example, as a special display is changed in color into a different color, e.g., red as a normal display, and this new surrounding mark 132 surrounding the character string “♦□□ . . . ” is displayed in blue as a special display.

Subsequently, FIG. 2B illustrates the state of the screen 130 immediately after a series of input operation of drawing a (wavy) underline just below another new character string “ [symbol] . . . ” by handwriting. That is, following the series of input operation to draw the underline below the character string “ [symbol] . . . ”, the surrounding mark 131 of the character string “◯◯◯ . . . ” displayed in red as a normal display remains as it is, whereas the display in blue as a special display so far is changed into a surrounding mark 133 as a normal display and the underline mark 134 as a special display for the character string “ [symbol] . . . ” is displayed in blue. The following may describe a surrounding mark and an underline mark simply as a mark collectively.

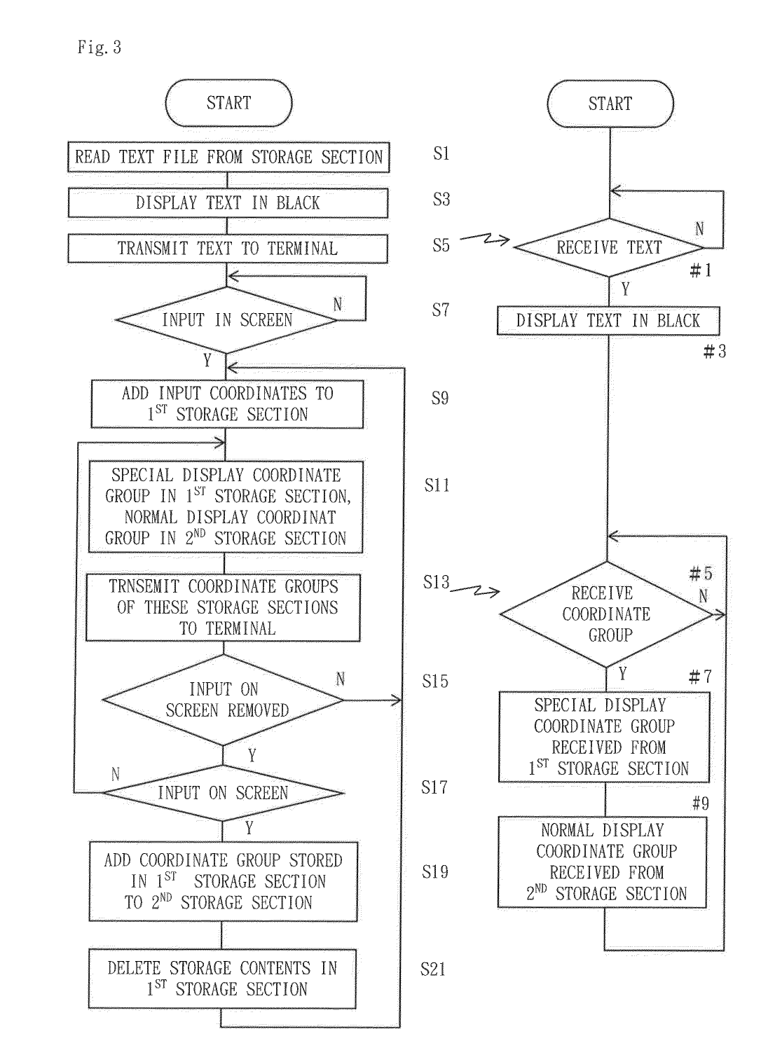

Referring next to the flowchart of FIG. 3, the procedure of the drawing processing illustrated in FIGS. 2A and 2B is described below. To begin with, during an electronic conference, the main device 1 issues an instruction to read a text file from the storage section 12 (Step S1). In response to the instruction to read a text file, this flowchart starts. Firstly, the text file read is displayed in black on the screen 130 of the display section 13 by the draw processing section 111 (Step S3). Next, the read text file is transmitted (delivered) to a terminal 2 participating in the electronic conference (Step S5).

When the terminal 2 participating in the electronic conference receives the text file transmitted from the main device 1 (Step #1), the terminal 2 displays the same text file as that on the display section 13 to the screen of the display section 23 (Step #3).

Subsequently, a determination is made about the presence or not of an input to the screen, i.e., an input operation (pen-down operation) through the tablet 15 (Step S7). When, an input is performed on the screen, coordinates input are additionally written on the first storage section 121 (Step S9), and so the first storage section 121 stores the trace of the input coordinates as drawing information (first drawing information). Then, a special display (first drawing form) is performed at the positions of a group of the coordinates written on the first storage section 121, and a normal, display (second drawing form) is performed based on drawing information (second drawing information) corresponding to the positions of a group of coordinates written on the second storage section 122 (Step S11). That is, the coordinate positions of the input coordinates group this time are associated with image data in blue at a predetermined level, and the coordinate positions of the old input coordinates group are associated with image data in red at a predetermined level, which are then synthesized with the corresponding text files, and are guided to the display section 13 for display. Next, the coordinates groups stored in the first storage section 121 and the second storage section 122 are transmitted to the terminal 2 participating in the electronic conference (Step S13).

Receiving the drawing information containing coordinates groups transmitted from the main device 1 (Step #5), the terminal 2 participating in the electronic conference writes it to the storage section 22 and synthesizes it with the corresponding text files. The resultant is written at the screen of the display section 23, whereby the same special display as that on the display section 13 is performed (Steps #7, #9).

Next, a determination is made as to whether the input to the screen is ended (i.e., pen-up operation) or not (Step S15). The procedure returns back to Step S9 until a end of input is detected, where the storage processing of input coordinates and special display and normal display processing are repeated. Considering instability of the operation of a handwriting operation, for example, it is preferable to provide a predetermined duration of dead zone for the detection of the end of input. In this case, if coordinates before and after an operation are distant by a predetermined distance or more, for example, such an operation may be considered as a new pen-down operation in spite of within the duration of the dead-zone.

On the other hand, when the end of input is detected, then a determination is made about the presence or not of an input to the screen (Step S17). That is, a detection of another new input to the screen starts. The procedure returns to Step S11 until such a new input to the screen is detected, and similar processing is repeated.

When it is determined that a new input is performed to the screen, the coordinates group stored in the first storage section 121 are added to the second storage section 122 (Step S19), and then the stored contents in the first storage section 121 are deleted (reset) (Step S21). At Steps S19 to S21, every time a new input, operation starts on the screen, the mark displayed as a special display immediately before the operation is rewritten as a normal display, whereby a newly displayed mark and the old mark used so far can be displayed in different drawing forms. In this way, every time a new mark is displayed, the position of such a mark can be easily noted, and the old mark also can be noted again.

### Embodiment 2

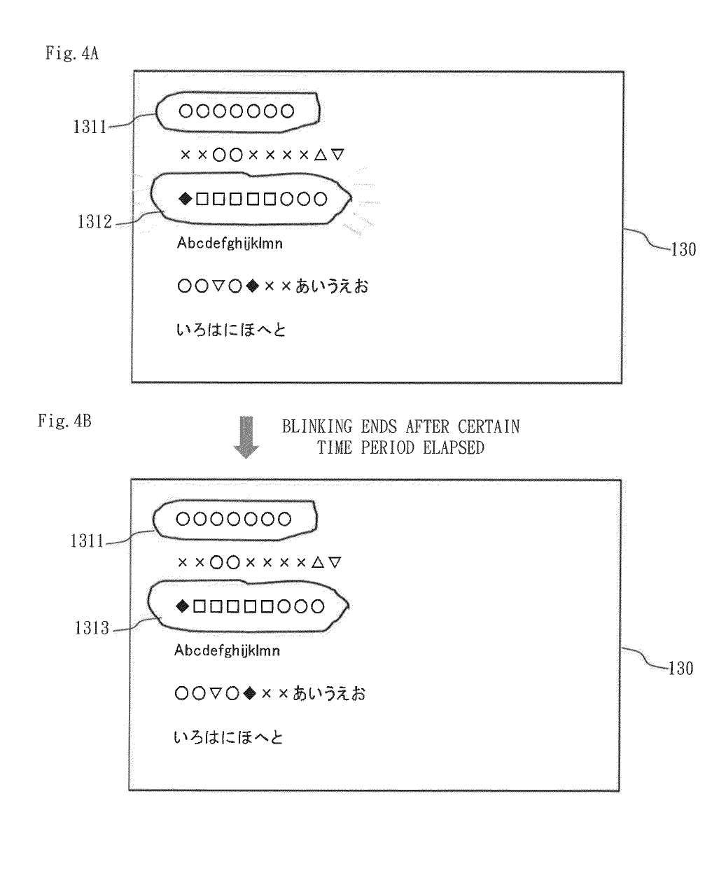

Referring next to FIGS. 4A and 4B, the following describes a second drawing method in accordance with drawing information. The second drawing method is as follows. When an input operation to the tablet 15 is detected periodically, drawing information for specific display (first drawing form) is created from the time when the input operation for each period is detected until a certain condition holds, e.g., until a predetermined time period has elapsed, and the drawing information is then displayed at the display section 13 (and the display section 23). Next, when the predetermined time period has elapsed, drawing information corresponding to the elapse of the predetermined time period is rewritten with drawing information for normal display, and then normal display (display in a second drawing form) is performed at the display section 13 (and the display section 23) in accordance with the drawing information after rewriting.

FIG. 4A illustrates a screen 130 that displays the same text file as that in FIG. 2A. As illustrated in FIG. 4A, the screen 130, on which a surrounding mark 1311 is already displayed, displays a surrounding mark 1312 as a new input. The surrounding mark 1311 is in the form of normal display, and the surrounding mark 1312 is in the form of special display. In this case, the special display means a blinking display, and the normal display means a lit-up display. The special display and the normal display may be the same or be different in color. The blinking display can be implemented by alternately repeating the reading of image data of the surrounding mark 1312 that is stored at the storage section 12 and a break of the reading at a predetermined period, e.g., for each predetermined frame number.

Then, when a predetermined time period has elapsed since the stating of the display, the surrounding mark 1312 in the form, of special display is changed into normal display as in a surrounding mark 1313 illustrated in FIG. 4B. In this way, the special display automatically returns to the normal display after a certain time period has elapsed irrespective of a next new input. This can avoid unnecessary attention of a user taken to the same position due to the special display kept all the time when it takes a long time before the next input. The image on the screen 130 in FIGS. 4A and 4B is transmitted to the terminal 2, which is displayed similarly on the screen of the display section 23 as well.

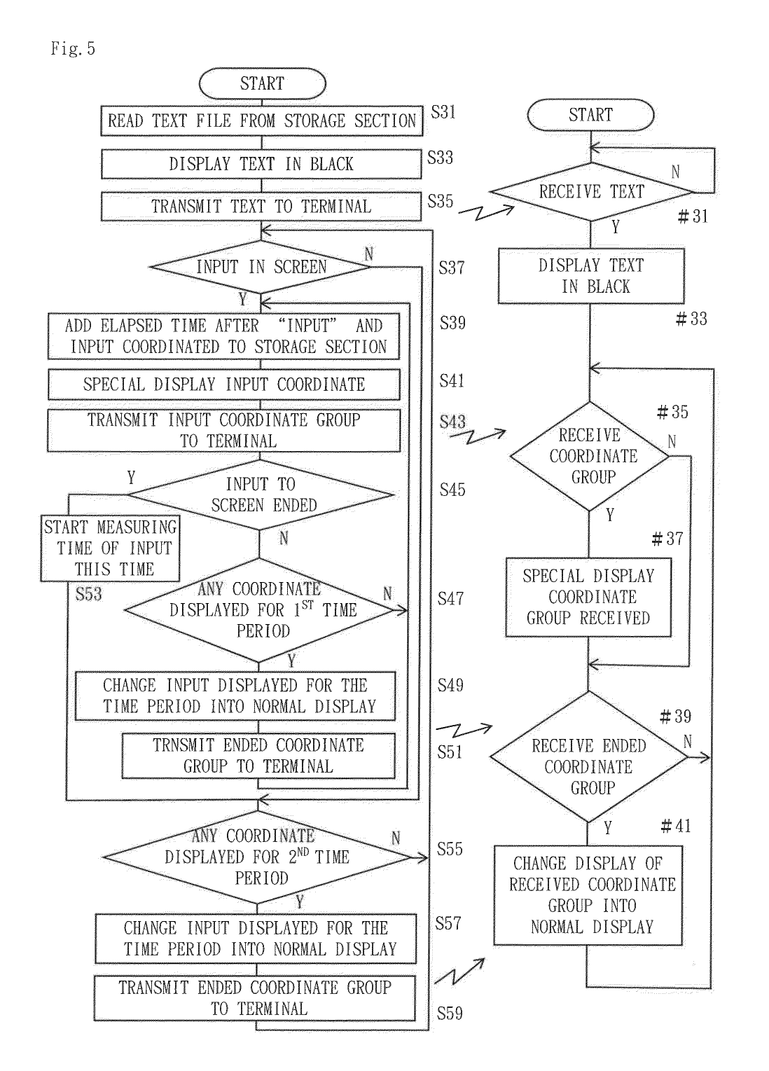

Referring next to the flowchart of FIG. 5, the following describes the procedure of the display processing illustrated in FIGS. 4A and 4B. Since there is no need to divide the storage section 12 into the first storage section 121 and the second storage section 122 in the flowchart of FIG. 5, it is described as the storage section 12. Since Step S31 to Step S35 and Step #31 to Step #33 are the same as Step S1 to Step S5 and Step #1 to Step #3 of FIG. 3, their descriptions are omitted.

Subsequently, a determination is made about the presence or not of an input to the screen, i.e., an input operation through the tablet 15 (Step S37). When an input is performed at the screen, coordinates input are additionally written on the storage section 12 together with information on elapsed time from the “input” (Step S39), and so the trace of the input operation as drawing information is stored in the storage section 12. Then, a special display is performed at the positions of a group of the coordinates written on the storage section 12 (Step S41). That is, the coordinate positions of the input coordinates group this time are associated with image data in red at a predetermined level, which are guided to the display section 13 for blinking display at a predetermined period. Next, the coordinates group input this time stored in the storage section 12 are transmitted to the terminal 2 participating in the electronic conference (Step S43).

Receiving the coordinates group input this time as drawing information that is transmitted from the main device 1 (Step #35), the terminal 2 participating in the electronic conference writes it to the storage section 22 and synthesizes it with the text file. The resultant is then read on the screen of the display section 23, whereby the same special display as that on the display section 13 is performed (Step #37).

Next, a determination is made as to whether the input to the screen is ended or not (Step S45). When the input is not ended, a determination is made about the presence or not of a coordinate that is displayed for a first time period after the inputting of the coordinate in the coordinates group input in the storage section 12 (Step S47). When there is no input coordinate displayed for the first time period, the procedure returns to Step S39. When any input coordinate is displayed for the first time period, the display of the input that is displayed for the first time period is changed to the normal display (Step S49) to be a ended coordinate group. Next, information on this ended coordinate group is transmitted to the terminal 2 participating in the electronic conference (Step S51), and the procedure returns to Step S39.

Receiving the drawing information containing the ended coordinate group transmitted from the main device 1 (Step #39), the terminal 2 participating in the electronic conference writes it to the storage section 22, reads it on the screen of the display section 23, and changes it into the same normal display as that at the display section 13 for display (Step #41).

On the other hand, when it is determined at Step S45 that the input is ended, a time-measuring operation for the input this time starts (Step S53). Next, in the input coordinate group, a determination is made about the presence or not of a coordinate input that is displayed for a second time period (>the first time period) after the end of the input (Step S55). Similarly, also when it is determined at Step S37 that input to the screen is not performed, the procedure proceeds to Step S55.

When there is no input coordinate that is displayed for the second time period at Step S55, the procedure returns to Step S37. On the other hand, when there is an input coordinate that is displayed for the second time period, the display of the input that is displayed for the second time period is changed to the normal display (Step S57) to be a ended coordinate group. Next, information on this ended coordinate group is transmitted to the terminal 2 participating in the electronic conference (Step S59), and the procedure returns to Step S37.

Receiving the drawing information containing the ended coordinate group transmitted from the main device 1 (Step #39), the terminal 2 participating in the electronic conference writes it to the storage section 22, reads it on the screen of the display section 23, and changes it into the same normal display as that at the display section 13 for display (Step #41).

### Embodiment 3

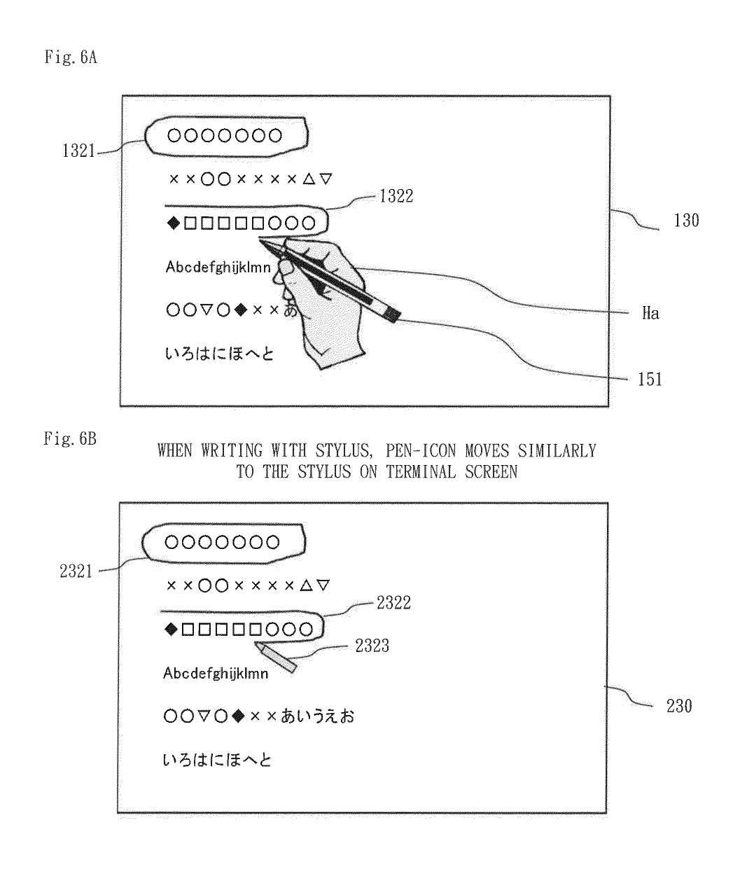

Referring next to FIGS. 6A and 6B, the following describes a third drawing method. FIG. 6A illustrates a screen 130 that displays the same text file as that in FIG. 2A. FIG. 6A illustrates the state where the screen 130 of the display section 13, on which a surrounding mark 1321 is already displayed, displays a surrounding mark 1322 that is being input newly. Specifically, a participant who operates the main device 1 holds a stylus 151 with his/her hand Ha, and inputs the surrounding mark 1322 on the face of the tablet 15, i.e., on the screen 130 of the display section 13 by handwriting. Meanwhile, a surrounding mark 2321 corresponding to the surrounding mark 1321 and a surrounding mark 2322 corresponding to the surrounding mark 1322 being drawn are displayed on the screen 230 of the display section 23 illustrated in FIG. 6B, and a pen icon 2323 is displayed together so as to make the participant of the conference having the terminal 2 recognize inputting being performed with a pen, which corresponds to the function of the stylus 151. In this way, a special display is performed so that, during handwriting, the surrounding mark 2322 and the pen icon 2323 are displayed together, whereby facilitating the recognition and confirmation of the handwriting position. This special display may end when a predetermined time period has elapsed after the end of the handwriting input or when another handwriting input starts.

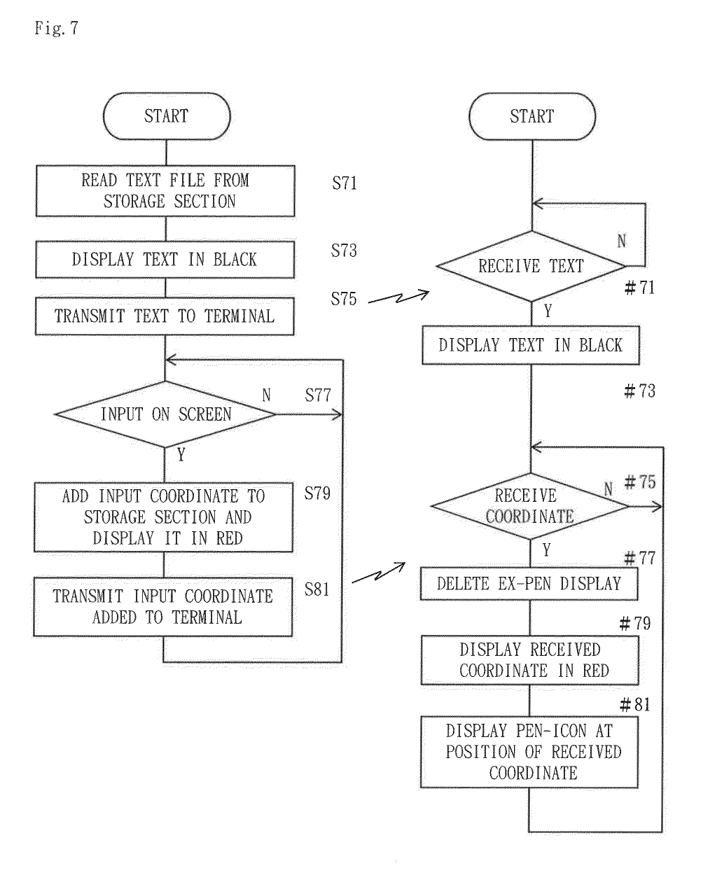

Referring next, to the flowchart of FIG. 7, the following describes the procedure of the drawing processing illustrated in FIGS. 6A and 6B. Similarly to FIG. 5, the flowchart of FIG. 7 describes the case where the coordinates input are stored at the storage section 12. Since Step S71 to Step S75 and Step #71 to Step #73 are the same as Step S1 to Step S5 and Step #1 to Step #3 of FIG. 3, their descriptions are omitted.

Subsequently, a determination is made at the main device 1 about the presence or not of an input to the screen, i.e., an input operation through the tablet 15 by handwriting (Step S77). When an input is performed at the screen, coordinates input are additionally written on the storage section 12, and so the trace of the handwriting operation as drawing information is stored in the storage section 12, and display in red is instructed at the positions of the coordinates group written in the storage section 12 (Step S79). That is, the coordinate positions of the input coordinates group as the handwriting trace are associated with image data in red at a predetermined level, which are guided to the display section 13 for display. Next, in the input coordinates group that is stored in the storage section 12, a newly added one is transmitted to the terminal 2 participating in the electronic conference (Step S81). Then, the procedure returns to Step S77, and while the input is continued, similar processing is repeated.

Receiving the drawing information containing the input coordinates corresponding to the added one as drawing information that is transmitted from the main device 1 (Step #75), the terminal 2 participating in the electronic conference writes it to the storage section 22. Subsequently the pen icon 2323 currently being displayed is deleted (Step #77), then the input coordinates group is read from the storage section 22, and the same surrounding mark 2322 as that at the display section 13 is displayed in red on the screen 230 of the display section 23 (Step #79). Then, a new pen icon 2323 is displayed at the position of the input coordinates that are the most recently added on the screen of the display 23 (Step #81). This results in the display of both of the surrounding mark and the pen icon 2323 on the screen 230 of the display section 23 of the terminal 2 as a special display.

Such a special display may be configured so that the pen icon 2323 is deleted based on a determination that a predetermined time period has elapsed after the ending of a series of input operation or a determination that another input operation is performed.

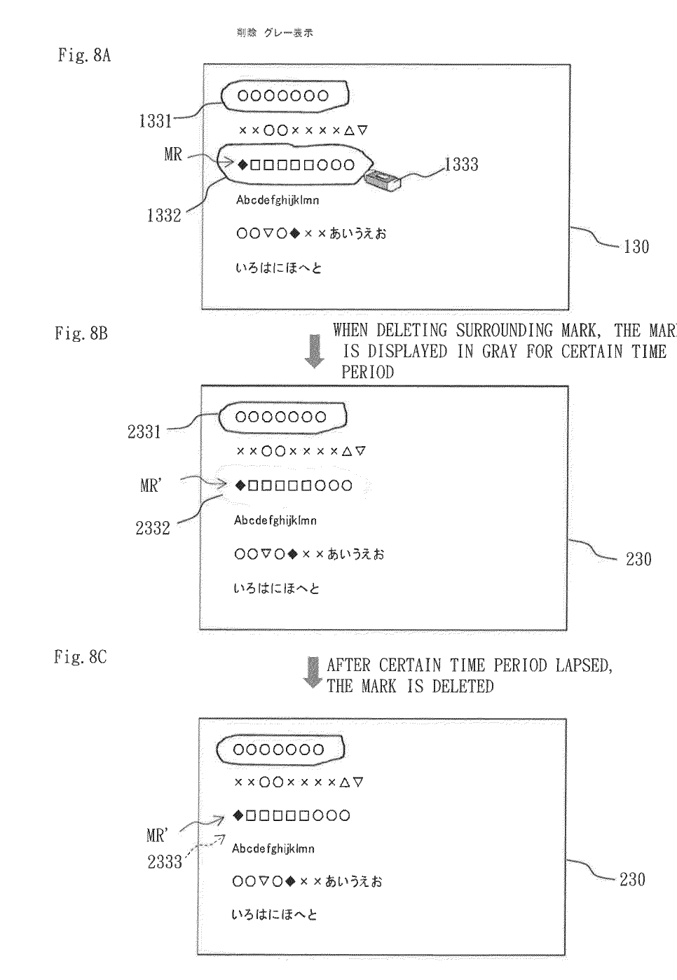

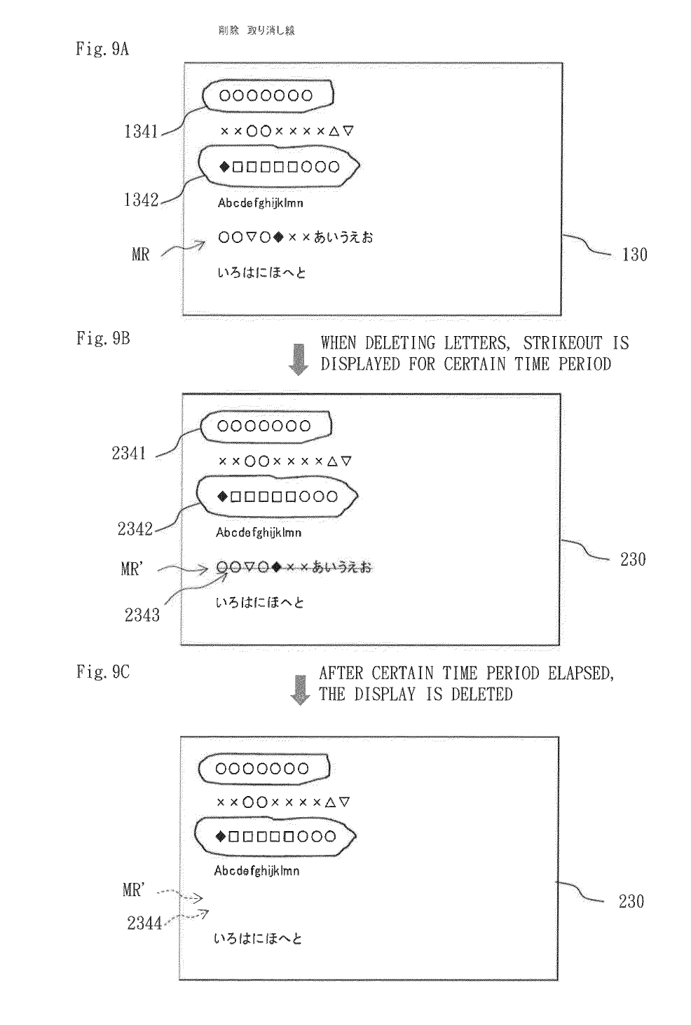

FIGS. 8A, 8B, 8C, 9A, 9B and 9C describe a drawing method to delete the contents relating to a special display after performing the special display. A fourth drawing method illustrated in FIGS. 8A, 8B and 8C is as follows. As illustrated in FIG. 8A, a text file similar to that of FIG. 2A is displayed on the screen 130 of the display section 13, where surrounding marks 1331 and 1332 as a normal display are displayed. Then, an eraser ion 1333 corresponding to the function to instruct deletion is selected, and an instruction is issued to delete the surrounding mark 1332 by the input operation to trace over the surrounding mark 1332 surrounding a character string MR that is already drawn. Then, when the surrounding mark 1332 is deleted at the main device 1, such drawing information is transmitted to the terminal 2. As a result, as illustrated in FIG. 8B, a surrounding mark 2332 is changed to a special display in a different color on the screen 230 of the display section 23 of the terminal 2, and is displayed only for a certain time period. For instance, the display form may be changed from red as in the surrounding mark 2331 to another display form, in this case, to gray that is a display form that suggests “deletion”. Instead of gray color, the display may be changed to a low-brightness display or to a blinking display as a special display. Instead of the certain time period, the display time period may be set until any other input is performed next.

Then, when the certain time period has elapsed, as illustrated in FIG. 8C, the surrounding mark 2333 is deleted, and the display includes a character string MR′ only. In this way, when a surrounding mark, once displayed, is deleted as well, the drawing processing is performed so as to delete the surrounding mark via the stage of a special display, and so the participant easily can check and recognize the place undergone the change on the screen 230.

In the case of a fifth drawing method illustrated in FIGS. 9A, 9B and 9C, a text file similar to that of FIG. 2A is displayed on the screen 130 of the display section 13, send as illustrated in FIG. 9A, surrounding marks 1341 and 1342 as a normal display are displayed. Let here that an input instruction operation to delete a character string MR from the screen 130 through the tablet 15 is performed and the character string MR is deleted. Such designation of the deletion function may be performed by a designation method with the tablet 15 as well as via an operation through the operating section 16 of the main device 1. Then a deletion instruction and information to specify the character string MR as a deletion target are transmitted as drawing information from the main device 1 to the terminal 2.

As illustrated in FIG. 9B, a strikeout icon 2343 as a mark to indicate the deletion function is displayed on the character string MR′ for a certain time period as a special display on the screen 230 of the display section 23 of the terminal 2. Instead of the certain time period, the display time period may be set until any other input is performed next.

Then, when the certain time period has elapsed, as illustrated in FIG. 9C, drawing processing to delete both of the character string MR′ and the strikeout icon 2344 is executed. In this way, when a part of a text file is deleted as well, the drawing processing for deletion is performed via the stage of a special display, and so the participant easily can check and recognize the place undergone the change on the screen 230. The mark for deletion processing as the second drawing form may be a mark indicating other functions such as changing of a part of a text file in the display form (e.g., change in color, enlargement) or additionally displaying, other than the illustrations of FIGS. 8A to 8C and FIGS. 9A to 9C.

An image file as a display target may be a binary data file instead of a text file.

Instead of a change from blinking display to lit-up display or a change in color, a method for changing from a special display to a normal display may be a change in brightness, a change in the thickness of a line when the display includes a line drawing, a change from a cyclic display using different colors to a lit-up display using one color as Embodiment 2. In the first drawing method in FIGS. 2A and 2B, a blinking display method may be used for the special display, and in the second drawing method of FIGS. 4A and 4B, a display method in blue may be used for the special display.

Embodiment 1 describes the position designation by a handwriting input operation to the tablet 15, and the present invention is not limited to this. For instance, as illustrated in FIG. 9A, for example, a display position of the character MR as a part of the image file being displayed may be designated by an input operation to the operating section 16 as Embodiment 3. Alternatively, a function may be designated with the operating section 16 and a position for execution of the function may be designated with the tablet 15.

The electronic conferencing system illustrated in FIGS. 1A and 1B is described in the configuration made up of one main device 1 and a plurality of terminals 2, and the present invention is not limited to such an embodiment. As Embodiment 4, an electronic conferencing system may be executed among a plurality of terminals. In this case, each terminal includes a control program installed therein to execute an electronic conference or may download such a program from a not-illustrated administrative server or the like for activation. The terminal 2 may be equipped with a tablet 15 similarly to the main device 1, and may create drawing information similarly to the main device 1, whereby both of them can have a function of transmission.

FIG. 5 illustrates the configuration such that the display time period of a special display is changed with the presence or not of another new series of input. Alternatively, a more basic drawing method may be used, for example, where the display time period of a special display may be fixed to a predetermined time period as Embodiment 5.

The above described embodiments are to be considered in all respects as illustrative and not restrictive. The scope of the invention is indicated by the appended claims rather than by the foregoing description. All changes which come within the meaning and range of equivalency of the claims are intended to be embraced therein.

What is claimed is:

1. An information processing apparatus having a display section to perform a communication with another information processing apparatus having a display section to share an image file therewith, and to display the image file at both of the display sections of the information processing apparatuses so as to progress an electronic conference therebetween, comprising:
an input section that receives a designation operation of a position on a screen of the display section; and
a drawing information creation section that creates first drawing information, based on which a designation position designated by the input section is displayed in a first drawing form, and second drawing information, based on which, when a predetermined condition holds after reception of the designation position, display of the designated position is changed into a second drawing form, wherein
the information processing apparatus transmits the first and the second drawing information to the other information processing apparatus.

2. The information processing apparatus according to claim 1, wherein the predetermined condition includes reception of another new series of designation operation.

3. The information processing apparatus according to claim 1, wherein the predetermined condition includes display being performed for a predetermined time period in the first drawing form.

4. The information processing apparatus according to claim 3, wherein the drawing information creation section differentiates the predetermined time period depending on presence or not of reception of the another new series of designation operation.

5. The information processing apparatus according to claim 1, wherein the first drawing form is to display the designation position in a first color, and the second drawing form is to display the designation position in a second color different from the first color.

6. The information processing apparatus according to claim 1, wherein the first drawing form is to display the designation position in a blinking state, and the second drawing form is to display the designation position in a lit-up state.

7. The information processing apparatus according to claim 1, wherein the second drawing information is to display the designation position viewably.

8. The information processing apparatus according to claim 1, wherein the second drawing information is to delete drawing at a designation position in the first drawing form.

9. The information processing apparatus according to claim 1, further comprising a main drawing processing section that performs drawing processing in accordance with the first and the second drawing information at the display section.

10. An electronic conferencing system, comprising the information processing apparatus according to claim 1 and the other information processing apparatus, wherein
the other information processing apparatus includes a sub-drawing processing section that performs a drawing processing at a display section in accordance with the first and the second drawing information that is transmitted from the information processing apparatus.

11. The electronic conferencing system according to claim 10, wherein
the information processing apparatus includes a function setting section that sets a function,
the drawing information creation section incorporates information on the set function in the first and the second drawing information, and
the sub-drawing processing section additionally draws a functional mark corresponding to the set function during the drawing processing in accordance with the first drawing information and executes the set function in accordance with the second drawing information.
